(19) United States
(12) Patent Application Publication
(10) Pub. No.: US 2023/0068209 A1
(43) Pub. Date: Mar. 2, 2023

(54) GAME CONTROLLER ON MOBILE TOUCH-ENABLED DEVICE

(71) Applicant: Min Seob HAN, Seoul (KR)

(72) Inventor: Min Seob HAN, Seoul (KR)

(21) Appl. No.: 18/045,016

(22) Filed: Oct. 7, 2022

Related U.S. Application Data
(63) Continuation of application No. PCT/KR2021/003820, filed on Mar. 29, 2021.

(30) Foreign Application Priority Data
Apr. 7, 2020 (KR) 10-2020-0042123

(51) Int. Cl. A63F 13/2145; A63F 13/24

(52) U.S. Cl. CPC A63F 13/2145; A63F 13/24

(57) ABSTRACT

The present invention relates to a game controller provided to control a game on a touch screen of various capacitive touch screen-based mobile devices. Specifically, the present invention relates to a game controller on a mobile touch-enabled device, which is mounted on a touch screen of a mobile device in a simple detachable manner and is provided to enable eight-directional steering (up/down/left/right/upper left/upper right/lower left/lower right) so as to provide promptness and accuracy in directions and inputs, and which provides an excellent touch feel and operational feel so as to arouse fun and interest in a game.

### CROSS-REFERENCE TO RELATED APPLICATION

This application is a continuation of International Patent Application No. PCT/KR2021/003820, filed on Mar. 29, 2021, which claims priority to and the benefit of Korean Patent Application No. 10-2020-0042123, filed on Apr. 7, 2020, the disclosure of which is incorporated herein by reference in its entirety.

### TECHNICAL FIELD

The present invention relates to a game controller provided to control a game on a touch screen of various mobile devices based on a capacitive touch screen, and more specifically, to a game controller on a touchable mobile device, which is mounted on a touch screen of a mobile device in a simple detachable manner to provide promptness and accuracy of direction and input by allowing eight-direction steering (up/down/left/right/up-left/up-right/down-left/down-right), and is capable of inducing fun and interest in a game by providing an excellent sense of touch and handling.

### BACKGROUND ART

Generally, a video game is a game using a computer program, in which a computer receives user's input, processes the input according to a set rule, and outputs the process or a result thereof, and includes an interaction with a user to generate visual feedback on a display.

The interaction with a user is usually realized using a game controller. The game controller may be used to control a game executed on a video game console, and this may make visual contents be rendered on a display (e.g., television, monitor, or the like).

Although a joystick including one button is used in the early stage of developing video games, gradually, a digital gamepad that allows eight-direction input using a cross key and a rubber keypad on a printed circuit board is mainly used. Recently, as video games become more complex, controllers having a plurality of analog and discrete inputs are developed and used.

For example, game controllers used in recently developed video game consoles usually include analog thumbstick(s), analog trigger(s), discrete button(s), and/or directional pad(s).

The games that can be executed on a console like this are becoming more complex to take advantage of various inputs provided by latest controllers.

Meanwhile, supply and demand for various types of mobile devices that are easy to carry have increased rapidly in recent years owing to advancement in IT technologies.

Particularly, as the use of various mobile devices based on a capacitive touch screen, such as smartphones, tablet PCs, smart pads, or the like, increases to provide convenience in handling and using the devices, versions of console-based games that can be executed on a touchable mobile device can be seen more commonly.

However, there is a big qualitative difference between a user experience at a moment of interacting with a game version executed on a touchable mobile device of a compact design and a user experience at a moment of interacting with a game version executed on a console of a video game.

Since touchable mobile devices generally do not provide tactile feedback similar to that of controllers for video game consoles, they seriously spoil user's interest and fun.

Accordingly, game controllers for stably controlling a game executed on a touchable mobile device to increase interest and fun of a game are disclosed in Korean Patent Registration No. 10-1288648 (Registration Date: Jul. 16, 2013), Korean Patent Registration No. 10-1566438 (Registration Date: Oct. 30, 2015), Korean Utility Model No. 20-2014-0001543 (Publication Date: Mar. 13, 2014), and Korean Patent Registration No. 10-1566444 (Registration Date: October 30, 2015).

The game control methods proposed in Korean Patent Registration No. 10-1288648, Korean Patent Registration No. 10-1566438, and Korean Utility Model No. 20-2014-0001543 are methods of attaching a game controller to a mobile device in a suction method, and touching a point on a touch screen by tilting a conductive body to one side with the elasticity of a suction plate. However, this is not suitable for input of an eight-directional virtual pad that needs an accurate touch in a predetermined section since there is a disadvantage in that the suction plate is easily separated when a game control is used by applying force to the thumb, and a contact point touching the touch screen simultaneously touches undesired other adjacent parts of the virtual pad in different directions, and this results in high input error.

Korean Patent Registration No. 10-1566444 proposes a slide-type game control method. This is a method of making an input by pushing a conductive body in a desired direction using an elastic material. For example, when steering is made in an opposite direction, such as ‘up’ to ‘down’, ‘left’ to ‘right’, or the like, an input blank is generated as much as a touch screen space at the midpoint, and therefore, since it is difficult to quickly change the input of direction with the thumb, the property of promptness cannot be satisfied. In addition, like the prior art documents of the suction method described above, this is not suitable for input of an eight-directional virtual pad that needs an accurate touch in a predetermined section since there is a disadvantage in that the suction plate is easily separated when a game control is used by applying force to the thumb, and a contact point touching the touch screen simultaneously touches undesired other adjacent parts of the virtual pad in different directions, and this results in high input error.

In addition, a game controller integrated with a case, such as the one disclosed in Korean Patent Registration No. 10-1566438, cannot be used for different types of smartphones having a different size and shape, and since the shape is fixed, there is a disadvantage in that it is mainly used in the vertical direction, and used only on a small game screen.

In addition, as a wireless game controller using Bluetooth is not easy to carry as it is bulky, and is troublesome in using since it needs to be charged, it can be used only for a specific game compatible with a corresponding Bluetooth controller, and thus there is a limit in using the wireless game controller.

As described above, although the game controllers on a touchable mobile device according to the prior art known until now can be finely adjusted and suitable for a game of a 360° omnidirectional input method suitable for 3D games, they are not suitable for classic games that require an eight-direction input method that is used for a gamepad since the late 1970s and has a familiar sense of handling worldwide, and have a problem of lowering the fun and interest in a game due to the low speed and accuracy at the moment of making an input.

### PRIOR ART DOCUMENTS

(Patent Document 1) KR 10-1288648 B1 (Jul. 16, 2013)

(Patent Document 2) KR 10-1566438 B1 (Oct. 30, 2015)

(Patent Document 3) KR 20-2014-0001543 U (Mar. 13, 2014)

(Patent Document 4) KR 10-1566444 B1 (Oct. 30, 2015)

### DISCLOSURE OF INVENTION

### Technical Problem

Therefore, the present invention has been made in view of the above problems, and it is an object of the present invention to provide a game controller on a touchable mobile device, which is mounted on a touch screen of a mobile device in a simple detachable manner to provide promptness and accuracy of direction and input by allowing eight-direction steering (up/down/left/right/up-left/up-right/down-left/down-right).

In addition, another object of the present invention is to provide a game controller on a touchable mobile device, which can induce fun and interest in a game by providing a sense of grip and handling similar to that of a digital gamepad using a cross-shaped direction key and a rubber keypad on a printed circuit board and having a very familiar sense of handling as it has been used in gamepads for home video games since the late 1970s and used even in various gamepads until present.

### Technical Solution

To accomplish the above object, according to one aspect of the present invention, there is provided a game controller detachably installed on a mobile device based on a capacitive touch screen to control a game executed through the touch screen of the mobile device with a cross-shaped direction key, the game controller comprising: a cross-shaped game pad including: a detachable member fixed to the mobile device; a cover accommodating the cross-shaped direction key and including an upper surface unit and a lower surface unit; the cross-shaped direction key coupled to pass through a coupling hole formed in the upper surface unit of the cover; and a rubber keypad positioned between the cross-shaped direction key and the lower surface unit of the cover to transfer static electricity of a user transferred through the cross-shaped direction key to the touch screen, wherein the cross-shaped direction key includes: a cross-shaped handling unit pressed by handling of the user; key members exposed upward through the coupling hole of the upper surface unit of the cover to transfer the static electricity of the user to the rubber keypad on the bottom; and an axis unit protruding downward below the bottom of the cross-shaped handling unit, and the rubber keypad includes: a base supported by the lower surface unit of the cover; four touch units facing the key members up and down and extended from the base to be tapered toward the top to transfer the static electricity of the user to the touch screen when the key members are pressed; and a hole corresponding to the axis unit.

In an embodiment, the cross-shaped handling unit and the key member may be made of a single conductive material.

In an embodiment, the cross-shaped direction key may be formed in a shape in which the center portion on the top of the cross-shaped handling unit is divided in an X-shape, or may be formed in a cross shape protruding on the top of a circular handling unit exposed to the outside.

In an embodiment, the base and the four touch units of the rubber keypad may be made of a single conductive material.

In an embodiment, each of the four touch units may include: a leg unit tapered from the base toward the top to be extended in a circular form, and made of an elastic material; a first connection unit formed on the top of the leg unit; a second connection unit formed at the bottom-center of the leg unit to be in contact with the touch screen of the mobile device; and a connection unit connecting the first connection unit and the second connection unit up and down.

In an embodiment, the first connection unit, the second connection unit, and the connection unit may be made of a single conductive material.

### Advantageous Effects

As described above, according to the present invention, as a cross-shaped gamepad and/or a button-type gamepad mounted on a touch screen of a mobile device in a simple detachable manner to allow eight-direction steering (up/down/left/right/up-left/up-right/down-left/down-right) is provided, it is possible to provide promptness and accuracy of direction and input of an eight-direction virtual pad, and induce fun and interest in a game by providing an excellent sense of touch and handling.

### BRIEF DESCRIPTION OF THE DRAWINGS

FIG. 1 is a view showing a game controller according to an embodiment of the present invention.

FIG. 2 is an assembled perspective view showing a cross-shaped gamepad according to an embodiment of the present invention.

FIG. 3 is an exploded perspective view showing the cross-shaped gamepad shown in FIG. 2.

FIGS. 4A-4B are partial cross-sectional views showing a part of the cross-shaped gamepad shown in FIG. 2 taken by cutting up and down.

FIG. 5 is an enlarged cross-sectional view showing the rubber keypad shown in FIGS. 4A-4B.

FIG. 6 is a cross-sectional view illustrating operation characteristics of a cross-shaped gamepad according to an embodiment of the present invention.

FIGS. 7A-7B are views showing a cross-shaped direction key according to an embodiment of the present invention.

FIGS. 8A-8F are cross-sectional views showing various implementation methods of a cross-shaped direction key according to an embodiment of the present invention.

FIGS. 9A-9B are views showing various shapes of a cross-shaped direction key that can be applied to a cross-shaped direction key according to an embodiment of the present invention.

FIGS. 10A-10D are views showing a cross-sectional structure according to the fixing method of a detachable member. FIGS. 10A and 10B are views showing tongs-type and clip-type detachable members, FIG. 10C is a view showing a compression-type detachable member, FIG. 10D is a view showing an adhesive-type detachable member.

### BEST MODE FOR CARRYING OUT THE INVENTION

The advantages and features of the present invention, and methods for achieving them, will become apparent with reference to the embodiments described below in detail, together with the accompanying drawings. However, the present invention is not limited to the embodiments disclosed below, and will be implemented in various different forms.

In this specification, the embodiment is provided to make the disclosure of the present invention complete, and to completely inform the scope of the invention to those skilled in the art. In addition, the present invention is only defined by the scope of the claims. Accordingly, in some embodiments, well-known components, well-known operations, and well-known techniques will not be described in detail to avoid obscure interpretation of the present invention.

In addition, like reference numerals refer to like elements throughout the specification. In addition, the terms used (mentioned) in this specification are for describing the embodiments and are not intended to limit the present invention.

In this specification, singular forms also include plural forms unless specifically stated otherwise in the phrase. In addition, elements and operations referred to as ‘include (or provided with)’ do not exclude the presence or addition of one or more other elements and operations.

Unless otherwise defined, all the terms (including technical and scientific terms) used in this specification may be used as a meaning commonly understood by those skilled in the art. In addition, the terms defined in generally used dictionaries are not to be interpreted ideally or excessively unless the terms are defined.

Hereinafter, technical features of the present invention will be described in detail with reference to the accompanying drawings.

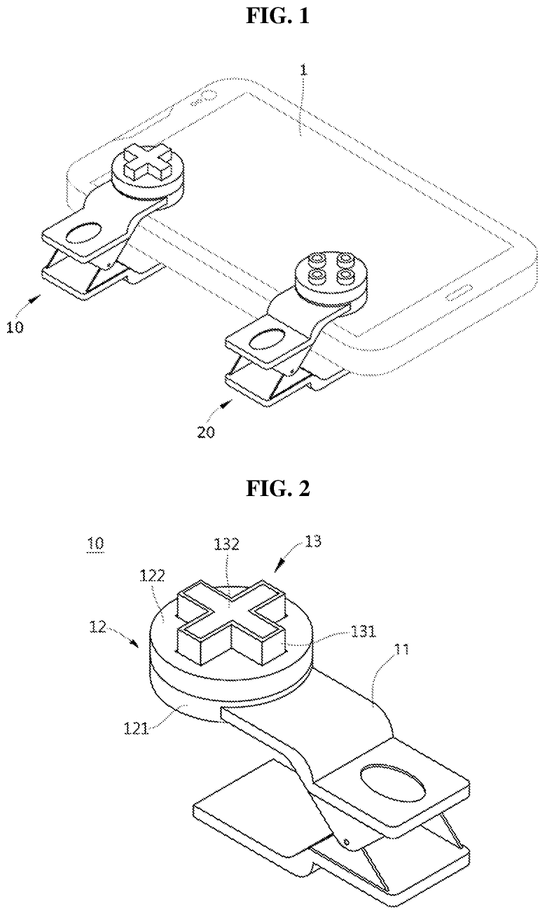

FIG. 1 is a view showing a state of actually attaching a game controller on a mobile device (e.g., a smartphone) in order to describe a game controller on a touchable mobile device according to an embodiment of the present invention.

Referring to FIG. 1, a game controller 10 according to an embodiment of the present invention may include a cross-shaped gamepad 10 detachably installed on various mobile devices 1 based on a capacitive touch screen, to control (steer) various games executed through the touch screen of the mobile device 1, for example, a classic game that requires an eight-direction input method, in eight directions.

The mobile device 1 may be a smartphone, a smart pad, a tablet PC, or the like. In addition, any mobile device based on a capacitive touch screen may be applied.

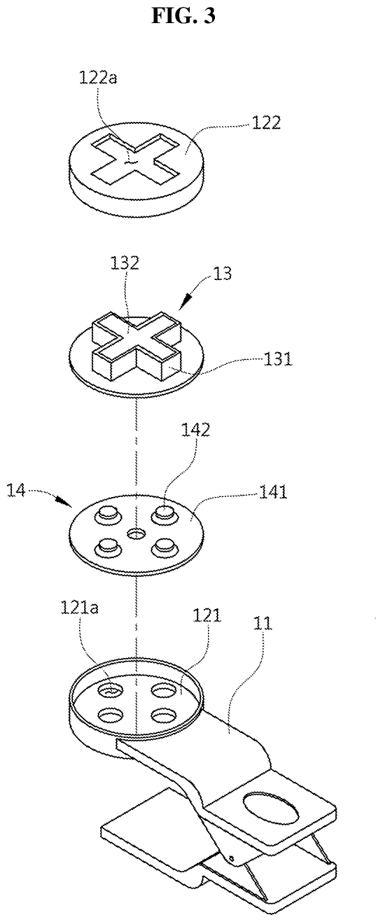

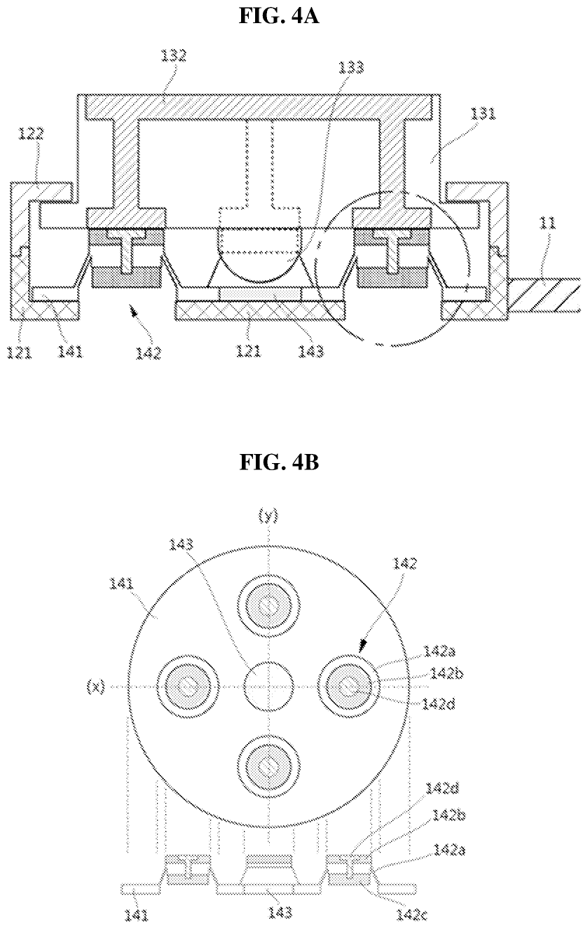

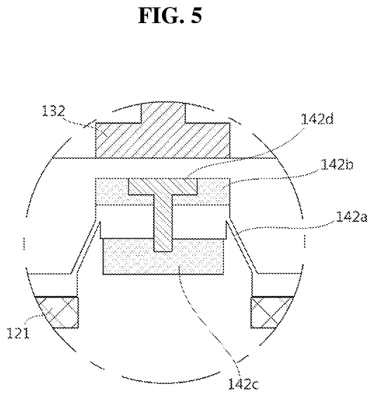

FIG. 2 is an assembled perspective view showing a cross-shaped gamepad according to the present invention, FIG. 3 is an exploded perspective view showing the cross-shaped gamepad shown in FIG. 2, and FIGS. 4A-4B are an enlarged partial cross-sectional view showing a part of the cross-shaped gamepad shown in FIG. 2 taken by cutting up and down.

Referring to FIGS. 2 to 4A-4B, a cross-shaped gamepad 10 according to the present invention may include a detachable member 11 for detachably fixing the gamepad 10 to a mobile device 1, a cover 12 formed at one side of the detachable member 11 and configured of an upper surface unit 122 and a lower surface unit 121 coupled up and down, a cross-shaped direction key 13 having a cross-shaped handling unit 131 coupled to pass through a cross-shaped coupling hole 122a formed in the upper surface unit 122 of the cover, and a rubber keypad 14 installed between the cross-shaped direction key 13 and the lower surface unit 121 of the cover to face the touch screen of the mobile device 1 through the through holes 121a of the lower surface unit 121 of the cover, and made of an elastic material to get in touch with the touch screen of the mobile device 1 and transfer static electricity of a finger pressing the cross-shaped direction key 13 to the touch screen of the mobile device 1 when pressing force of the finger is transferred downward through the cross-shaped direction key 13.

The detachable member 11 is for fixing the gamepad 10 to the mobile device 1, and the method or form is not particularly limited.

Referring to FIGS. 2 and 3, although the detachable member 11 may be of a tongs type attached to the mobile device 1 through a pair of arms, it is not limited thereto, and may be a clip type, a compression type, or an adhesive type.

The tongs-type detachable member 11 may be fixed in a way of holding a predetermined portion as the end is split into two parts.

The clip-type detachable member 11 may be fixed to the mobile device 1 in an insertion way using elasticity or the like.

The compression-type detachable member 11 is made of a soft material and may be fixed to tightly contact with the touch screen of the flat mobile device 1 as the shape changes by pressure.

The adhesive-type detachable member 11 may be repeatedly attached to and detached from the touch screen of the mobile device 1 through a sticky material.

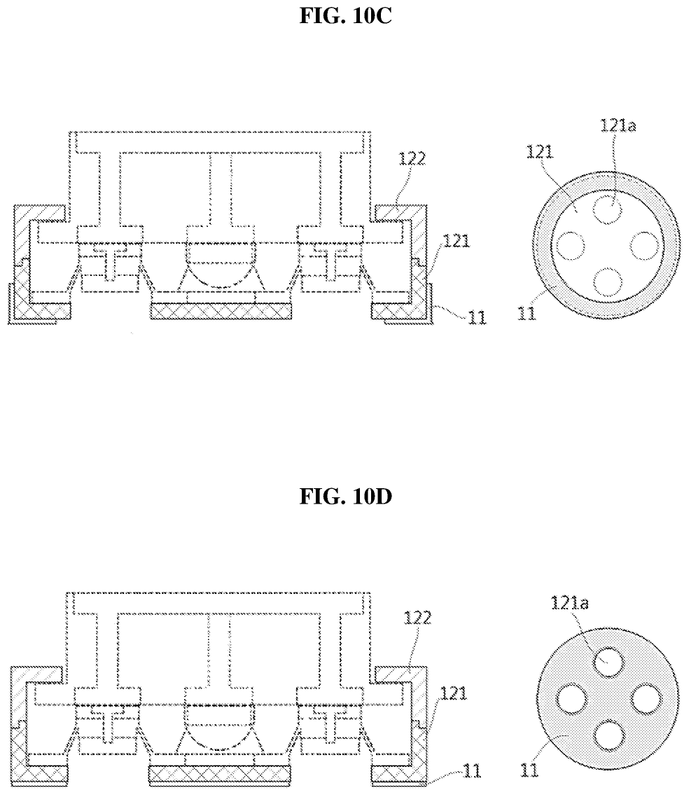

Referring to FIGS. 10A-10D, the structures and coupling forms of the detachable member 11 may be partly different according to the fixing method.

The tongs-type or clip-type detachable member may have the cross-sectional structures shown in FIGS. 10A and 10B according to the coupling form of the lower surface unit 121 and the upper surface unit 122 of the cover.

The compression-type detachable member 11 may have the cross-sectional structure shown in FIG. 10C, and the adhesive-type detachable member 11 may have the cross-sectional structure shown in FIG. 10D, and according to the fixing method, the coupling form of the detachable member 11 and the lower surface unit 121 of the cover, or the shape of the bottom surface of the detachable member 11 may vary.

Although the cover 12 may be configured of an upper surface unit 122 and a lower surface unit 121 in a cylindrical shape as shown in FIG. 2, it is not limited thereto, and may be formed in various shapes that may accommodate the cross-shaped direction key 13 and the rubber keypad 14.

The cross-shaped direction key 13 is for steering directions in various games executed through the touch screen of the mobile device 1, and may include a cross-shaped handling unit 131 passing through the coupling hole 122a of the upper surface unit of the cover and protruding toward the outside, a key member 132 having an upper part exposed toward the outside (top) of the cross-shaped handling unit 131 and a lower part in contact with the rubber keypad 14 to transfer static electricity of the user to the rubber keypad 14, and an axis unit 133 having a structure protruding downward at the bottom center of the cross-shaped handling unit 131.

When pressing force is transferred in one direction of the key member 132, the axis unit 133 rotates the cross-shaped handling unit 131 according to the pressing force based on the axis unit 133, and thus may prevent occurrence of unintended input error of other adjacent touch units.

That is, the axis unit 133 may improve operability by preventing interference of adjacent areas during the operation of the key member 132. Although one end of the axis unit 133 is formed in a hemispherical shape to facilitate rotation of the cross-shaped direction key, the shape or size is not particularly limited.

Referring to FIG. 3, the cross-shaped direction key 13 may be formed to have an outer surface protruding in a circular shape not to be separated upward through the coupling hole 122a of the upper surface unit 122 of the cover. At this point, the outer surface of the cross-shaped direction key 13 is not particularly limited in the shape or size as long as it is not separated through the coupling hole 122a.

The key member 132 is for transferring static electricity of a finger to the touch screen of the mobile device 1, and a total of four key members including left, right, up, and down key members may be provided around the center portion of the cross-shaped handling unit.

Although the key members 132 may be made of a conductive material, for example, a conductive plastic or a metal material, in order to transfer static electricity of the finger, it is not limited thereto.

The upper portion of the key member 132 may be exposed to the outside to contact with a finger, and the lower portion of the key member 132 may be stacked with the touch unit of the rubber keypad 14 to be in contact up and down.

At this point, the height of the bottom surface of the key member 132 (the portion in contact with the upper portion of the touch unit 142 of the rubber keypad 14) may be the same as or different from that of the bottom surface of the cross-shaped handling unit 131.

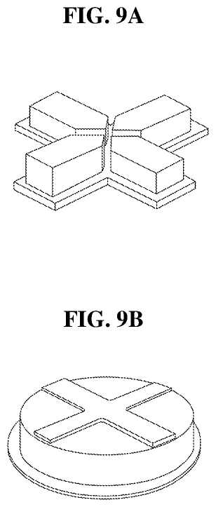

Referring to FIGS. 8A-8F, the key member 132 is a structure capable of transferring static electricity of the user to the rubber keypad 14, and may be sufficient as long as it can connect the upper and lower portions, and the structure, shape, area, volume, material, and the like are not particularly limited.

The rubber keypad 14 may include a base 141 and a touch unit 142.

Referring to FIG. 3, the touch unit 142 may be formed in a cross shape (four) on the base 141, and is extended from the base 141 to be tapered to face the key member 132 up and down to come into contact with the touch screen of the mobile device 1 when a user's finger presses the key member 132 and transfer static electricity of the user's finger transferred through the key member 132 to the touch screen of the mobile device 1.

A hole 143 may be formed at the center inside the touch unit 142 so that the axis unit 133 may pass through and be supported by the lower surface unit 121 of the cover when a finger presses the cross-shaped direction key 13.

The hole 143 is a portion corresponding to the axis unit 133 protruding downward at the bottom center of the cross-shaped handling unit 131. When the cross-shaped direction key operates, the axis unit 133 may support smooth operation as it is stably supported by the lower surface unit 121 of the cover, rather than the upper portion of the base 141 of the rubber keypad 14 having elasticity.

The shape of the hole 143 may be a spherical shape, and its shape is not particularly limited as long as the axis unit 133 may pass through and be supported by the lower surface unit 121 of the cover.

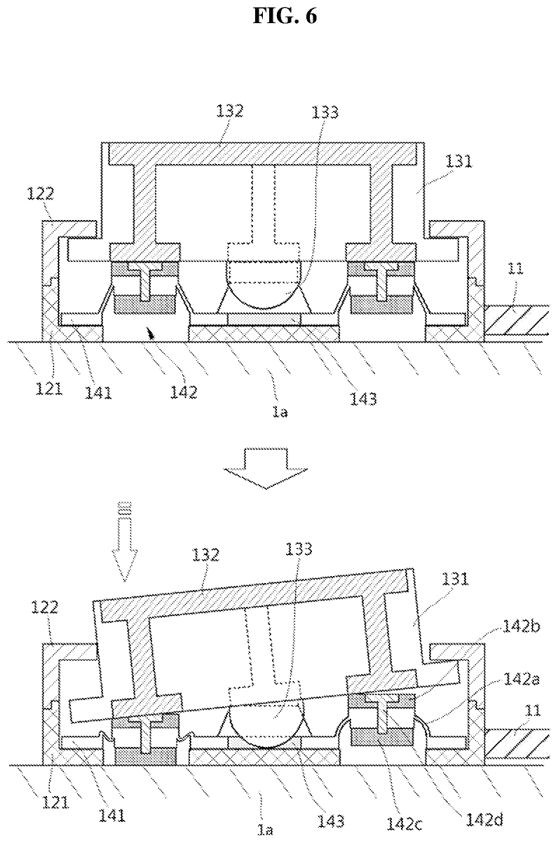

FIG. 5 is an enlarged cross-sectional view showing the rubber keypad shown in FIGS. 4A-4B.

Referring to FIGS. 4A-4B and 5, the rubber keypad 14 may include a base 141, and a plurality of touch units 142 formed on the base 141 to face the key members 132 up and down to be in contact with the key members 132 when a finger applies pressure to transfer static electricity transferred through the key members 132 to the touch screen of the mobile device 1.

Referring to FIG. 3, although the base 141 may be a circular shape, it is not limited thereto, and may be various shapes such as an oval or polygonal shape (square shape, rhombus shape, or the like).

The base 141 may be made of an elastic material, like the rubber keypad used for general digital gamepads.

Referring to FIGS. 4A-4B, four touch units 142 may be formed to one-to-one correspond to the key members 132. The touch units 142 may be aligned up and down to face the key members 132.

Referring to FIG. 4B, the touch units 142 may be positioned in a regular cross shape around the vertical intersection of the (x) axis and the (y) axis. When the touch units 142 are not equally spaced apart from the vertical intersection, handling in a diagonal direction (e.g., top-left) may not be implemented accurately.

Referring to FIGS. 4A-4B and 5, the touch unit 142 may include a leg unit 142a tapered from the base 141 toward the top to be spaced apart from the touch screen of the mobile device 1 as much as a predetermined distance, and made of an elastic material, a first connection unit 142b formed on the top of the leg unit 142a, a second connection unit 142c formed at the bottom-center of the leg unit 142a to be in contact with the touch screen of the mobile device 1, and a connection unit 142d connecting the first and second connection units 142b and 142c up and down.

The leg unit 142a may be made of an elastic material the same as that of the base 141 to be integrated with the base 141.

The first and second connection units 142b and 142c are electrically connected to the key member 132 when a finger applies pressure, and made of a metal or a conductive material to transfer static electricity transferred through the key member 132 to the touch screen of the mobile device 1, and preferably, they may be made of a conductive rubber, such as carbon black or the like, in order to provide an excellent sense of touch through the elastic force.

Referring to FIG. 5, the connection unit 142d is for electrically interconnecting the first and second connection units 142b and 142c up and down, and may be made of a conductive material, such as a metal material, a conductive plastic, or the like.

On the other hand, the first connection unit 142b, the second connection unit 142c, and the connection unit 142d of the touch unit 142 may be integrated with each other as shown in FIG. 5, rather than being separated from each other, i.e., made of a single conductive material such as carbon black, conductive rubber, or the like.

In addition, the base 141 and the touch unit 142 of the rubber keypad 14 may be formed of a single conductive material such as conductive rubber or the like having elasticity.

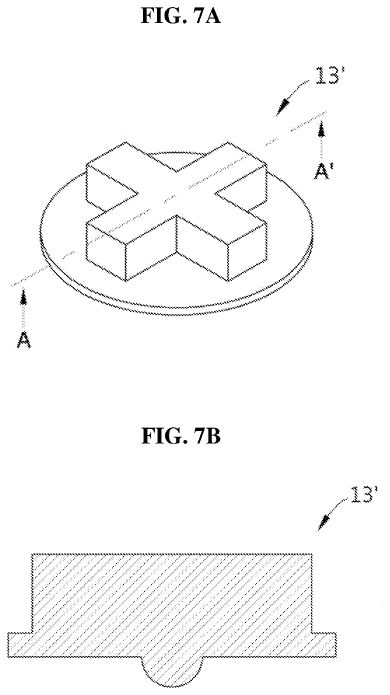

FIG. 6 is a cross-sectional view illustrating operation characteristics of a cross-shaped gamepad according to the present invention.

Referring to FIGS. 1 and 6, the cross-shaped gamepad 10 may be fixedly installed on the touch screen 1a of the mobile device 1 via the detachable member 11. At this point, the cross-shaped direction key 13 may be installed to correspond to a contact point for controlling direction in a game executed through the touch screen 1a.

Then, when the key member 132 of the cross-shaped direction key 13 is pressed to one side using a finger (thumb) to control the direction during a game, the key member 132 is inclined in a direction pressed with respect to the axis unit 133, and the touch unit 142 of the rubber keypad 14 aligned on the bottom side is pressed by the key member 132, and therefore, the first connection unit 142b of the touch unit 142 is electrically connected to the key member 132, and the second connection unit 142c may be in contact with the touch screen la of the mobile device 1.

As a result, as the key member 132 and the touch screen 1a are electrically connected to each other through a corresponding touch unit 142, and static electricity generated by the finger pressing the key member 132 to one side is transferred to the touch screen 1 a through the key member 132 and the touch unit 142, control of direction may be achieved.

In the manner as described above, the key members 132 of the cross-shaped gamepad 10, i.e., the four key members 132 on the upper, lower, left, and right sides, are independently handled to steer in the up, down, left, and right directions, and the up-left/up-right/down-left/down-right directions may be controlled by handling (pressing) two key members 132 simultaneously.

For example, the ‘up-left’ direction may be controlled by simultaneously handling the up key member and the left key member, the ‘up-right’ direction may be controlled by simultaneously handling the up key member and the right key member, the ‘down-left’ direction may be controlled by simultaneously handling the down key member and the left key member, and the ‘down-right’ direction may be controlled by simultaneously handling the down key member and the right key member.

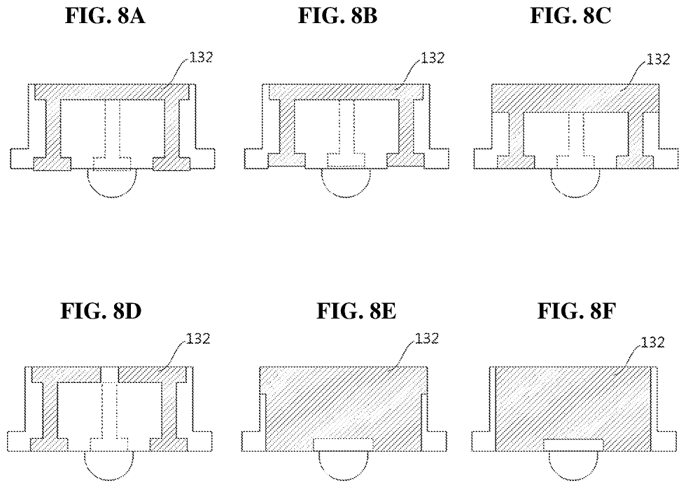

FIGS. 7A-7B are views showing a cross-shaped direction key according to another embodiment of the present invention, and A is a perspective view, and B is a cross-sectional view taken along the A-A′ shown in A.

Referring to FIGS. 7A-7B, in the cross-shaped direction key 13′ according to another example of the present invention, the cross-shaped handling unit and the key members may be made of a single conductive material.

That is, in the cross-shaped direction key 13′, unlike the cross-shaped direction key 13 according to the example shown in FIGS. 4A-4B, the cross-shaped handling unit and the key members may be made of a single conductive material such as a metal, a conductive plastic, or the like.

The cross-shaped direction key 13′ may be formed to have an outer surface protruding in a circular shape so as not to be separated upward through the coupling hole of the upper surface unit of the cover. At this point, the outer surface of the cross-shaped direction key 13′ is not particularly limited in the shape or size as long as it is not separated through the coupling hole.

Meanwhile, the present invention is by no means limited to the shape of the cross-shaped direction key proposed in the embodiments described above, and may include various known shapes.

That is, the cross-shaped direction key includes a key member and an axis unit, and the shape of the cross-shaped handling unit may be changed variously.

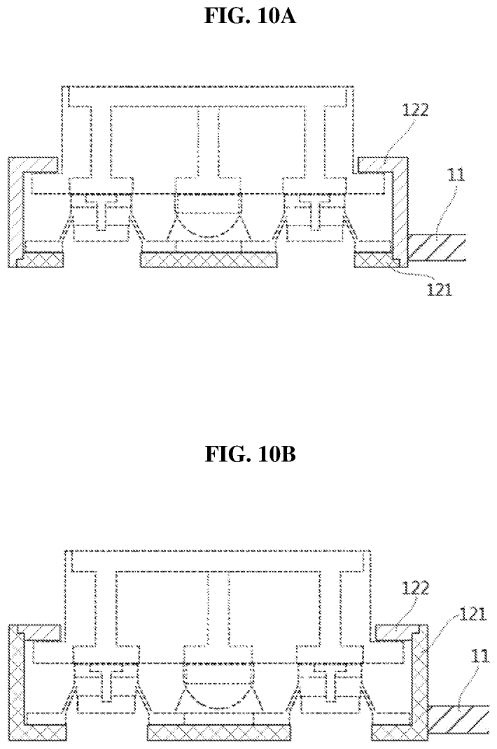

Various shapes that can be applied to the cross-shaped direction key of the present invention are shown in FIGS. 9A-9B.

FIGS. 9A-9B are views showing various shapes of a cross-shaped direction key that can be applied to a cross-shaped direction key according to the present invention, and FIG. 9A is a view showing a cross-shaped direction key applied to a PlayStation, and FIG. 9B is a view showing a cross-shaped direction key applied to a Sega Saturn.

Referring to FIGS. 9A-9B, the present invention is not limited to the shapes of the cross-shaped direction keys shown in FIGS. 1 and 7A-7B, and it may include a design of a cross-shaped direction key applied to various game controllers currently widely used in basic structures including a cover and a rubber keypad, for example, game controllers of Nintendo, PlayStation, Sega Saturn, and the like.

For example, as shown in FIG. 9A, the cross-shaped direction key may be formed in a shape in which the center portion on the top of a cross-shaped handling unit exposed to the outside through the coupling hole of the upper surface unit of the cover is divided in an X-shape.

In addition, as shown in FIG. 9B, the cross-shaped direction key may be formed in a cross shape protruding on the top of a circular handling unit exposed to the outside.

In addition, the cross-shaped direction key may be applied to all the various shapes applied to known game controllers.

Although the technical spirit of the present invention has been specifically described in the preferred embodiment as described above, the preferred embodiment described above is to described, not to limit, the present invention. As such, those skilled in the art may understand that various embodiments are possible through combination of the embodiments of the present invention within the scope of the technical spirit of the present invention.

### EXPLANATION OF CODE

1: Mobile device
1a: Touch screen
10: Cross-shaped gamepad
11: Detachable member
12: Cover
121: Lower surface unit of cover
121a: Through hole
122: Upper surface unit of cover
122a: Coupling hole
13, 13′: Cross-shaped direction key
131: Cross-shaped handling unit
132: Key member
133: Axis unit
14: Rubber keypad
141: Base
142: Touch unit
142a: Leg unit
142b: First connection unit
142c: Second connection unit
142d: Connection unit
143: Hole
20: Button-type gamepad

1. A game controller detachably installed on a mobile device based on a capacitive touch screen to control a game executed through the touch screen of the mobile device with a cross-shaped direction key, the game controller comprising:
a cross-shaped game pad including:
a detachable member fixed to the mobile device;
a cover accommodating the cross-shaped direction key and including an upper surface unit and a lower surface unit;
the cross-shaped direction key coupled to pass through a coupling hole formed in the upper surface unit of the cover; and
a rubber keypad positioned between the cross-shaped direction key and the lower surface unit of the cover to transfer static electricity of a user transferred through the cross-shaped direction key to the touch screen, wherein
the cross-shaped direction key includes:
a cross-shaped handling unit pressed by handling of the user;
key members exposed upward through the coupling hole of the upper surface unit of the cover to transfer the static electricity of the user to the rubber keypad on the bottom; and
an axis unit protruding downward below a bottom of the cross-shaped handling unit, and
the rubber keypad includes:
a base supported by the lower surface unit of the cover;
four touch units facing the key members up and down and extended from the base to be tapered toward a top to transfer the static electricity of the user to the touch screen when the key members are pressed; and
a hole corresponding to the axis unit.

2. The game controller according to claim 1, wherein the cross-shaped handling unit and the key member are made of a single conductive material.

3. The game controller according to claim 1, wherein the cross-shaped direction key is formed in a shape in which a center portion on the top of the cross-shaped handling unit is divided in an X-shape, or is formed in a cross shape protruding on the top of a circular handling unit exposed to the outside.

4. The game controller according to claim 1, wherein the base and the four touch units of the rubber keypad are made of a single conductive material.

5. The game controller according to claim 1, wherein each of the four touch units includes:
a leg unit tapered from the base toward the top to be extended in a circular form, and made of an elastic material;
a first connection unit formed on the top of the leg unit;
a second connection unit formed at a bottom-center of the leg unit to be in contact with the touch screen of the mobile device; and
a connection unit connecting the first connection unit and the second connection unit up and down.

6. The game controller according to claim 5, wherein the first connection unit, the second connection unit, and the connection unit are made of a single conductive material.
